(19) United States
(12) Patent Application Publication
(10) Pub. No.: US 2025/0076802 A1
(43) Pub. Date: Mar. 6, 2025

(54) RECORDING MEDIUM STORAGE DEVICE AND IMAGE FORMING APPARATUS

(71) Applicant: FUJIFILM Business Innovation Corp., Tokyo (JP)

(72) Inventor: Yohei ONOUE, Kanagawa (JP)

(73) Assignee: FUJIFILM Business Innovation Corp., Tokyo (JP)

(21) Appl. No.: 18/434,742

(22) Filed: Feb. 6, 2024

(30) Foreign Application Priority Data
Sep. 1, 2023 (JP) 2023-141919

(51) Int. Cl. G03G 15/00

(52) U.S. Cl. CPC G03G 15/5029; G03G 15/6511; G03G 15/6529

(57) ABSTRACT

A recording medium storage device includes a storage unit that stores a recording medium to be transported; a blowing unit that blows a gas onto the recording medium stored in the storage unit; and an imaging unit that is disposed on a downstream side of the storage unit in a recording medium transport direction, and that images the recording medium stored in the storage unit, at least a part of the imaging unit being movable in a direction separating from a transport path of the recording medium.

### CROSS-REFERENCE TO RELATED APPLICATIONS

This application is based on and claims priority under 35 USC 119 from Japanese Patent Application No. 2023-141919 filed Sep. 1, 2023.

### BACKGROUND

### (i) Technical Field

The present invention relates to a recording medium storage device and an image forming apparatus.

### (ii) Related Art

Japanese Unexamined Patent Application Publication No. 2015-024868 discloses a sheet feeding device which includes a blowing means that blows air onto a sheet bundle to cause an uppermost-layer sheet to float; and a transporting means that attracts the uppermost-layer sheet floated by the blowing means, and transports the sheet in a transport direction.

### SUMMARY

When a gas is blown onto a recording medium stored in a storage unit, the recording medium may be imaged using an imaging means to ascertain the condition of the recording medium onto which the gas is being blown.

Here, in the case of a configuration in which the imaging means is disposed on the downstream side of the storage unit in the recording medium transport direction, interference between the recording medium being transported from the storage unit and the imaging unit is likely to occur.

Aspects of non-limiting embodiments of the present disclosure relate to making interference less likely to occur between an imaging means that images a recording medium and the recording medium being transported, compared to a configuration in which the imaging means cannot be moved.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a recording medium storage device including: a storage unit that stores a recording medium to be transported; a blowing unit that blows a gas onto the recording medium stored in the storage unit; and an imaging unit that is disposed on a downstream side of the storage unit in a recording medium transport direction, and that images the recording medium stored in the storage unit, at least a part of the imaging unit being movable in a direction separating from a transport path of the recording medium.

### BRIEF DESCRIPTION OF THE DRAWINGS

Exemplary embodiments of the present disclosure will be described in detail based on the following figures, wherein:

FIG. 1 is a schematic configuration diagram illustrating an image forming apparatus;

FIG. 2 is a diagram illustrating a hardware configuration example of a control unit;

FIGS. 3A to 3D are views for describing a suction unit;

FIG. 4 is a perspective view of the suction unit taken from the direction of an arrow IV in FIG. 3A;

FIG. 5 is a view of a sheet storage device taken from the direction of an arrow V in FIG. 3A;

FIG. 6 is a view of the suction unit and a leading-end blowing device, taken from the side of a sheet bundle;

FIG. 7 is a view of the suction unit taken from the direction of an arrow VII in FIG. 3B;

FIGS. 8A and 8B are diagrams for describing an imaging mechanism;

FIG. 9 is a perspective view for describing the internal configuration of the imaging mechanism;

FIG. 10 is a diagram illustrating another configuration example of the imaging mechanism;

FIG. 11 is a diagram illustrating another configuration example of the imaging mechanism;

FIG. 12 is a diagram illustrating another configuration example of the imaging mechanism; and

FIG. 13 is a diagram illustrating another configuration example of the imaging mechanism.

### DETAILED DESCRIPTION

In the following, exemplary embodiments of the present invention will be described with reference to the accompanying drawings.

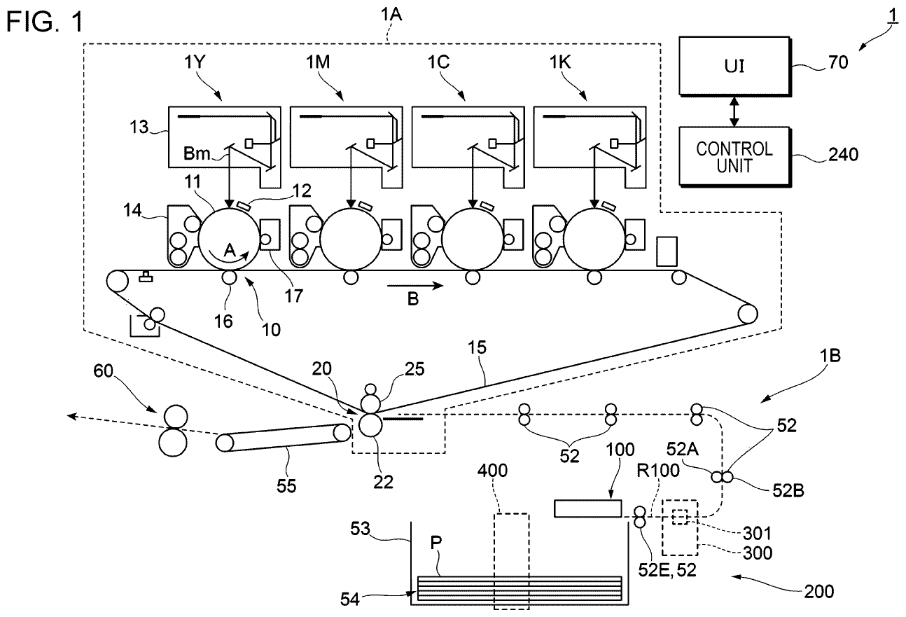

FIG. 1 is a schematic diagram of an image forming apparatus 1 according to an exemplary embodiment.

The image forming apparatus 1 illustrated in FIG. 1 is a tandem-type image forming apparatus based on an intermediate transfer system. The image forming apparatus 1 is provided with an image forming unit 1A that performs formation of an image on a sheet P, which is an example of a recording medium. The image forming apparatus 1 is provided with a sheet storage device 200 for storing sheets P.

The image forming unit 1A forms an image on the sheet P that has been fed and supplied from the sheet storage device 200.

In the image forming unit 1A as an example of an image forming unit, a plurality of image forming units 1Y, 1M, 1C, and 1K are provided, in which toner images of respective color components are formed by an electrophotographic method.

In addition, in the image forming unit 1A, a primary transfer section 10 is provided in which the toner images of the respective color components formed by the respective image forming units 1Y, 1M, 1C, and 1K are sequentially transferred onto an intermediate transfer belt 15. Further, in the image forming unit 1A, a secondary transfer section 20 is provided in which superimposed toner images transferred onto the intermediate transfer belt 15 are collectively transferred onto the sheet P.

The image forming apparatus 1 is also provided with a fixing device 60 that fixes the toner image secondarily transferred onto the sheet P to the sheet P.

The image forming apparatus 1 is further provided with a control unit 240 that controls the operation of each unit, and a user interface (UI) 70 that receives information from a user and displays information to the user.

The UI 70 is composed of a touch panel, for example, and has a reception function of receiving information from the user and a display function of displaying information. A device for realizing the reception function and a device for realizing the display function may be separately provided.

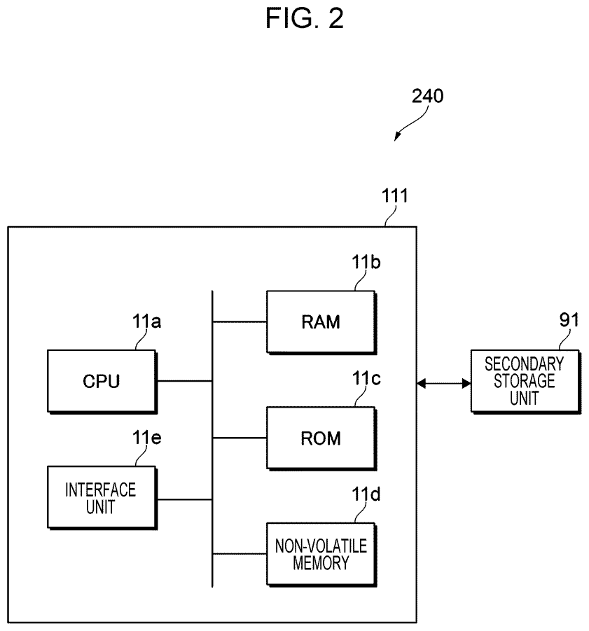

FIG. 2 is a diagram illustrating a hardware configuration example of the control unit 240. The control unit 240 is implemented by a computer.

The control unit 240 includes an arithmetic processing unit 111 that executes digital arithmetic processing in accordance with a program, and a secondary storage unit 91 that stores information.

The secondary storage unit 91 is implemented by an existing information storage device, such as, for example, a hard disk drive (HDD), a semiconductor memory, or a magnetic tape.

The arithmetic processing unit 111 is provided with a CPU 11a as an example of a processor.

The arithmetic processing unit 111 is also provided with a RAM 11b that is used as a working memory or the like for the CPU 11a, and a ROM 11c in which a program or the like executed by the CPU 11a is stored.

The arithmetic processing unit 111 is also provided with a non-volatile memory 11d which is configured to be rewritable and can retain data even when power supply is stopped.

The non-volatile memory 11d is composed of, for example, a battery-backed SRAM, a flash memory, or the like. The secondary storage unit 91 stores various kinds of information, such as a program executed by the arithmetic processing unit 111.

In the present exemplary embodiment, the CPU 11a of the arithmetic processing unit 111 reads a program stored in the ROM 11c or the secondary storage unit 91 to execute various types of processing performed in the image forming apparatus 1.

The program to be executed by the CPU 11a may be provided to the image forming apparatus 1 in a state of being stored in computer-readable recording media, such as magnetic recording media (magnetic tapes, magnetic disks, and the like), optical recording media (optical discs and the like), magneto-optical recording media, and semiconductor memories. The program to be executed by the CPU 11a may be provided to the image forming apparatus 1 by using a communication means, such as the Internet.

As used herein, the processor refers to a processor in a broad sense, and includes a general-purpose processor (e.g., CPU: central processing unit) and a dedicated processor (e.g., GPU: graphics processing unit, ASIC: application specific integrated circuit, FPGA: field programmable gate array, programmable logic devices, etc.).

The operation of the processor may be performed not only by one processor but also by a plurality of processors existing at physically separate locations and cooperating with each other. The order of the operations of the processor is not limited to only the order described in the present exemplary embodiment, but may be changed.

Referring to FIG. 1, the image forming apparatus 1 will be further described.

In each of the image forming units 1Y, 1M, 1C, and 1K, the following devices are installed.

First, a charger 12 that charges a photoconductor drum 11 is provided around the photoconductor drum 11, which rotates in the direction of an arrow A. Further, an exposure device 13 for writing an electrostatic latent image on the photoconductor drum 11 is provided. In addition, a developer 14 for developing the electrostatic latent image on the photoconductor drum 11 with toner is provided.

Each of the image forming units 1Y, 1M, 1C, and 1K is provided with a primary transfer roller 16 that transfers the toner image of each of the color components formed on the photoconductor drum 11 onto the intermediate transfer belt 15 in the primary transfer section 10.

Further, each of the image forming units 1Y, 1M, 1C, and 1K is provided with a drum cleaner 17 for removing residual toner and the like on the photoconductor drum 11.

The intermediate transfer belt 15 circulates at a predetermined speed in the direction of an arrow B illustrated in FIG. 1.

The primary transfer section 10 includes the primary transfer roller 16 that is disposed opposite the photoconductor drum 11 with the intermediate transfer belt 15 interposed therebetween.

In the present exemplary embodiment, the toner images on the respective photoconductor drums 11 are sequentially electrostatically drawn onto the intermediate transfer belt 15, and superimposed toner images are formed on the intermediate transfer belt 15.

The secondary transfer section 20 includes a secondary transfer roller 22 disposed opposite the outer peripheral surface of the intermediate transfer belt 15, and a backup roller 25.

The secondary transfer roller 22 is pressed against the backup roller 25 with the intermediate transfer belt 15 interposed therebetween. A voltage is applied between the secondary transfer roller 22 and the backup roller 25. In the present exemplary embodiment, the toner images on the intermediate transfer belt 15 are transferred onto the sheet P transported to the secondary transfer section 20.

In the present exemplary embodiment, image data is output from an image reading device, a personal computer (PC), or the like, not illustrated, to the image forming apparatus 1.

Then, image processing is performed on the image data by an image processing device, not illustrated, to generate image data of the four colors of Y, M, C, and K. The image data is output to the exposure devices 13 provided for the respective colors of Y, M, C, and K.

The exposure device 13 irradiates the photoconductor drum 11 of each of the image forming units 1Y, 1M, 1C, and 1K with an exposure beam Bm, which is emitted from a semiconductor laser, for example.

The exposure of the photoconductor drum 11 by the exposure device 13 is not limited to that using a semiconductor laser. The exposure of the photoconductor drum 11 may be performed using light emitted from a light emitting diode (LED) as a light source.

After the surface of the photoconductor drum 11 is charged by the charger 12, the surface is scanned and exposed by the exposure device 13 to form an electrostatic latent image.

After a toner image is formed on the photoconductor drum 11 by the developer 14, the toner image is transferred onto the intermediate transfer belt 15 in the primary transfer section 10, where the photoconductor drum 11 and the intermediate transfer belt 15 contact each other.

After the toner images are sequentially primarily transferred onto the surface of the intermediate transfer belt 15, the toner images are transported to the secondary transfer section 20 by the movement of the intermediate transfer belt 15.

In the secondary transfer section 20, the secondary transfer roller 22 is pressed against the backup roller 25 with the intermediate transfer belt 15 interposed therebetween.

Next, in the present exemplary embodiment, the sheet P transported from the sheet storage device 200 is pinched between the intermediate transfer belt 15 and the secondary transfer roller 22.

Thus, the unfixed toner images held on the intermediate transfer belt 15 are collectively electrostatically transferred onto the sheet P in the secondary transfer section 20. Thereafter, the sheet P having the toner images transferred thereon passes through the fixing device 60, and is ejected to a sheet ejection unit, not illustrated.

The sheet storage device 200 as an example of a recording medium storage device is provided with a storage unit 53 that stores stacked sheets P. The storage unit 53 is provided with, for example, a support base that supports the sheets P from below, and a side guide on which the sides of the sheets P are abutted to position the sheets P.

In the present exemplary embodiment, the uppermost sheet P of the sheets P stored in the storage unit 53 is fed out. Then, the toner image formed by the image forming unit 1A is transferred in the secondary transfer section 20 onto the sheet P that has been fed.

Furthermore, the sheet storage device 200 is provided with an imaging mechanism 300 as an example of an imaging unit for imaging the sheets P stored in the storage unit 53. The imaging mechanism 300 is disposed on the downstream side of the storage unit 53 in the transport direction of the sheet P.

The imaging mechanism 300 includes a light receiving unit 301 that receives reflected light from the sheet P.

The light receiving unit 301 is composed of, for example, a charge coupled device (CCD) or a complementary metal oxide semiconductor (CMOS). The light receiving unit 301 is not particularly limited, and any unit other than a CCD or a CMOS may be used as long as an image of the sheets P stored in the storage unit 53 can be acquired.

The light receiving unit 301 is disposed near a transport path R100 of the sheet P.

The light receiving unit 301 is movable in a direction separating from the transport path R100. More specifically, the light receiving unit 301 is movable downward. In the present exemplary embodiment, the light receiving unit 301 first crosses the transport path R100 by moving downward, and then moves further downward and away from the transport path R100.

In the present exemplary embodiment, as described above, at least a part of the imaging mechanism 300 is movable in a direction separating from the transport path R100 of the sheet P.

Furthermore, in the present exemplary embodiment, a lateral blowing device 400 is provided. In the present exemplary embodiment, the lateral blowing device 400 as an example of a blowing unit blows gas onto a side surface of a sheet bundle 54 formed of the sheets P stored in the storage unit 53. As a result, in the present exemplary embodiment, each of the sheets P constituting the sheet bundle 54 floats.

In the present exemplary embodiment, air is blown as the gas onto the sheet bundle 54. The type of the gas is not particularly limited, and a gas other than air may be blown onto the sheet bundle 54.

Furthermore, the sheet storage device 200 is provided with, above the sheet bundle 54, a suction unit 100 that suctions and holds the sheets P constituting the sheet bundle 54. The suction unit 100 suctions and holds the uppermost sheet P among the sheets P stored in the storage unit 53.

More specifically, the suction unit 100 suctions and holds the uppermost sheet P among the sheets P that are in a floating state due to the blowing of the gas by the lateral blowing device 400.

The imaging mechanism 300 images the sheets Ponto which the gas is being blown by the lateral blowing device 400.

Then, in the present exemplary embodiment, the CPU 11a (see FIG. 2) analyzes the captured image that is an image obtained by the imaging mechanism 300, and identifies the condition of the sheets P that are in a floating state due to the blowing of the gas.

Then, for example, if the sheets P are overlapped with each other and are in a condition prone to so-called double feeding, the control unit CPU 11a changes the output of the lateral blowing device 400, for example. Specifically, for example, the CPU 11a decreases the output of the lateral blowing device 400. As a result, the floating condition of the sheets P is changed.

Furthermore, in the present exemplary embodiment, a plurality of transport rollers 52 for transporting the sheet P sent out from the sheet storage device 200 are provided on the downstream side of the sheet storage device 200 in the transport direction of the sheet P.

Each of the transport rollers 52 is composed of a drive roller 52A that rotates by receiving a driving force from a motor (not illustrated), and a driven roller 52B that is disposed in contact with the drive roller 52A and rotates by receiving a driving force from the drive roller 52A.

In the exemplary embodiment, the sheet P fed from the sheet storage device 200 is first transported by the transport roller 52 located on the most upstream side in the transport direction of the sheet P (hereinafter, referred to as a “most-upstream transport roller 52E”) among the plurality of transport rollers 52.

Next, the sheet P is further transported by another transport roller 52 located on the further downstream side of the most-upstream transport roller 52E, and moves toward the secondary transfer section 20 and the fixing device 60.

Furthermore, a transport belt 55 is provided on the downstream side of the secondary transfer roller 22 in the transport direction of the sheet P. The transport belt 55 transports the sheet P on which the secondary transfer has been performed to the fixing device 60.

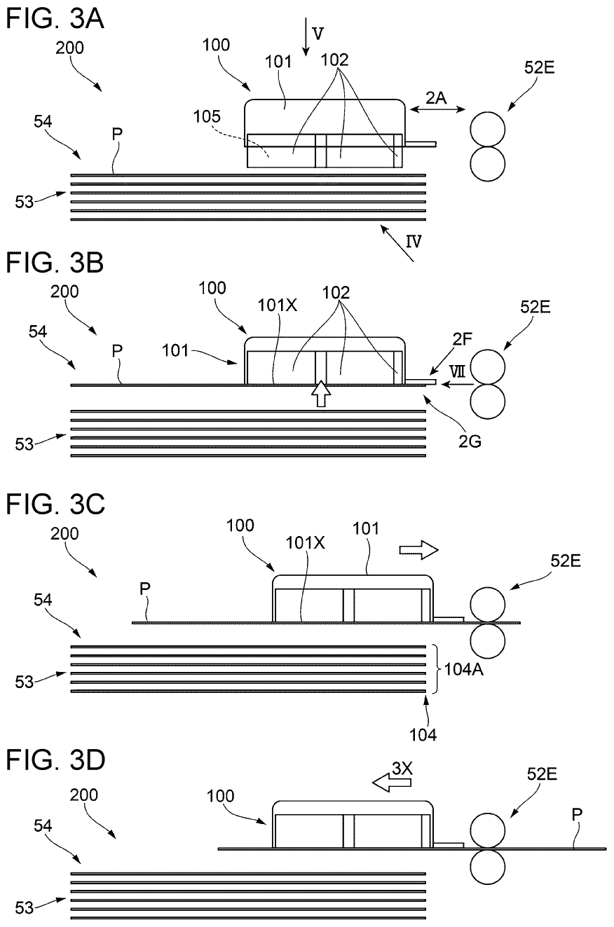

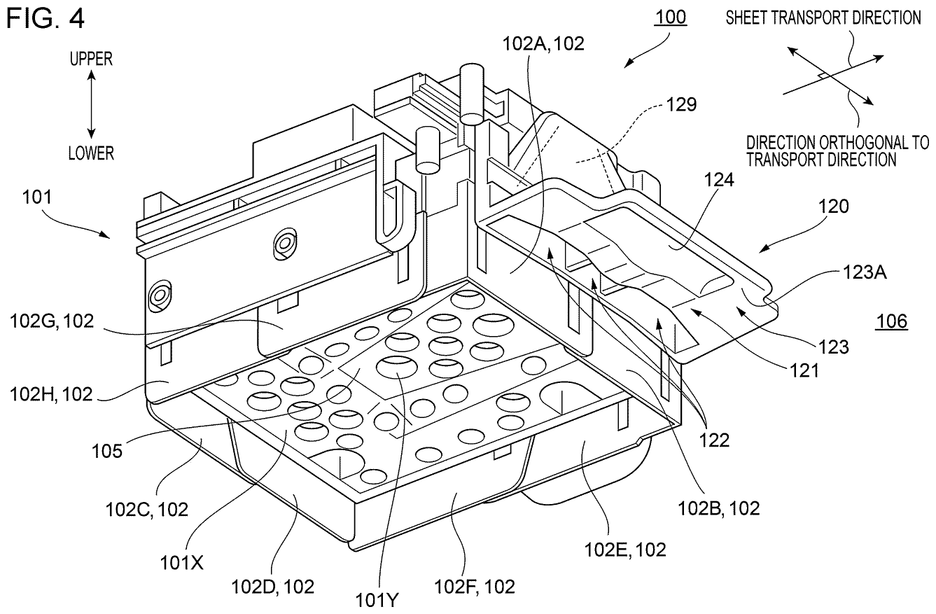

FIGS. 3A to 3D are diagrams illustrating the suction unit 100. FIG. 4 is a perspective view of the suction unit 100 taken from the direction of an arrow IV in FIG. 3A.

FIGS. 3A to 3D illustrate the state in which a sheet P is floating due to the blowing of gas by the lateral blowing device 400 (see FIG. 1). Note that the lateral blowing device 400 is not illustrated in FIGS. 3A to 3D.

As illustrated in FIG. 3A, the sheet storage device 200 is provided with the suction unit 100 that suctions the sheets P stacked in the storage unit 53. Further, a moving mechanism (not illustrated) for moving the suction unit 100 in a direction indicated by an arrow 2A in the drawing is provided.

Here, the moving mechanism may be composed of a known mechanism, such as a motor, a gear, a rack, a pinion, or a belt drive, and is not limited to a specific mechanism.

In the present exemplary embodiment, the moving mechanism moves the suction unit 100 in a direction approaching the most-upstream transport roller 52E or a direction separating from the most-upstream transport roller 52E, as indicated by an arrow 2A.

In the present exemplary embodiment, the moving mechanism moves the suction unit 100 from above the sheet bundle 54 in the direction approaching the most-upstream transport roller 52E.

Furthermore, in the present exemplary embodiment, the moving mechanism 304 causes the suction unit 100 that has moved toward the most-upstream transport roller 52E to move toward the sheet bundle 54 and to return to above the sheet bundle 54.

As illustrated in FIG. 3A, the suction unit 100 is provided with a cuboidal device body 101, and a plurality of moving members 102 which are provided in a state of being suspended from the device body 101.

A tube for suction (not illustrated) is connected to the device body 101, and the sheet P is suctioned by the device body 101 in the present exemplary embodiment, as will be described later.

The moving members 102 are formed in a plate shape and are provided to be movable in the vertical direction.

As illustrated in FIG. 4, the moving members 102 include a first leading-end moving member 102A, a second leading-end moving member 102B, a first rear-end moving member 102C, a second rear-end moving member 102D, a first right-side moving member 102E, a second right-side moving member 102F, a first left-side moving member 102G, and a second left-side moving member 102H.

By these eight moving members 102, a cuboidal depressurized space 105 located below the device body 101 and an atmospheric pressure space 106 located around the depressurized space 105 are partitioned.

The cuboidal space surrounded by the eight moving members 102 serves as the depressurized space 105. The space located outside the depressurized space 105 serves as the atmospheric pressure space 106, which is at atmospheric pressure.

A plurality of holes 101Y are formed in a lower surface 101X of the device body 101, and air in the depressurized space 105 is suctioned through the holes 101Y. Thus, the pressure in the depressurized space 105 becomes lower than the atmospheric pressure.

When the air in the depressurized space 105 is suctioned and the pressure of the depressurized space 105 decreases, as illustrated in FIGS. 3A and 3B, the sheet P located under the depressurized space 105 in a floating state is suctioned. The sheet P then moves toward the lower surface 101X (see FIG. 3B) of the device body 101.

Then, the sheet P adheres to the lower surface 101X. In other words, in the present exemplary embodiment, the sheet P is attracted to the lower surface 101X. More particularly, in the present exemplary embodiment, the sheet P is attracted to the lower surface 101X from below.

Here, the lower surface 101X is a flat surface. In the present exemplary embodiment, the lower surface 101X is a planar attracting portion, and the sheet P is attracted to the planar attracting portion.

When the sheet P is attracted to the lower surface 101X of the device body 101, the eight moving members 102 illustrated in FIG. 4 move upward from the state illustrated in FIG. 3A, and enter the state illustrated in FIG. 3B.

In the present exemplary embodiment, when the sheet P is attracted to the lower surface 101X illustrated in FIG. 4, the eight moving members 102 are pressed from below by the sheet P located below and move upward. Next, as the eight moving members 102 move upward, the sheet P is attracted to the lower surface 101X of the device body 101. When the sheet P is attracted to the lower surface 101X of the device body 101, a state is achieved where holding of the sheet P is being performed by the suction unit 100.

In addition, in the present exemplary embodiment, in the state where the sheet P is attracted to the lower surface 101X, as indicated by an arrow 2F of FIG. 3B, gas is blown onto an edge portion 2G of the sheet P attracted to the lower surface 101X, from the upper side of the lower surface 101X.

In the present exemplary embodiment, the gas is blown onto the edge portion 2G of the sheet P attracted to the lower surface 101X, from the upper side of the edge portion 2G.

The edge portion 2G illustrated in FIG. 3B is located at the leading end of the sheet P when the sheet P is transported (hereinafter, referred to as “leading-end edge portion 2G”). In the present exemplary embodiment, the gas is blown onto the leading-end edge portion 2G from above.

Details of blowing of the gas to the leading-end edge portion 2G will be described later.

Thereafter, in the present exemplary embodiment, as illustrated in FIG. 3C, the suction unit 100 moves toward the most-upstream transport roller 52E, and the sheet P attracted to the lower surface 101X of the device body 101 is supplied to the most-upstream transport roller 52E.

In this way, the transport of the sheet P by the most-upstream transport roller 52E is started.

In the present exemplary embodiment, the suction unit 100 moves in a direction intersecting the vertical direction and toward the most-upstream transport roller 52E.

Thus, the sheet P attached to the lower surface 101X of the device body 101 is supplied to the most-upstream transport roller 52E, and the transport of the sheet P by the most-upstream transport roller 52E is started.

Thereafter, in the present exemplary embodiment, the suction unit 100 moves in a direction indicated by an arrow 3X in FIG. 3D, and the suction unit 100 returns toward the sheet bundle 54.

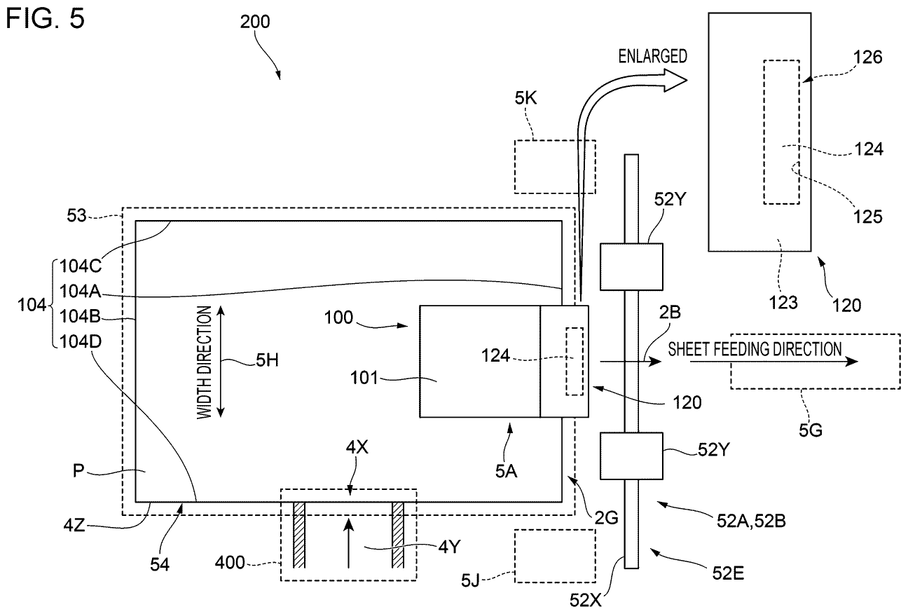

FIG. 5 is a diagram illustrating the sheet storage device 200 when viewed from the direction of an arrow V of FIG. 3A. In other words, FIG. 5 is a diagram when the sheet storage device 200 is viewed from above.

As illustrated in FIG. 5, in the present exemplary embodiment, the sheet bundle 54 in which a plurality of sheets P are arranged in the thickness direction thereof is placed in the storage unit 53. The sheet bundle 54 and each sheet P included in the sheet bundle 54 have a rectangular outer peripheral edge 104.

The rectangular outer peripheral edge 104 includes a leading-end outer peripheral edge 104A, a rear-end outer peripheral edge 104B, a first lateral outer peripheral edge 104C, and a second lateral outer peripheral edge 104D.

The leading-end outer peripheral edge 104A is the outer peripheral edge 104 located on the most downstream side in the transport direction of the sheet P. The leading-end outer peripheral edge 104A extends along a direction intersecting (orthogonal to) the transport direction of the sheet P.

The rear-end outer peripheral edge 104B is the outer peripheral edge 104 located on the most upstream side in the transport direction of the sheet P. The rear-end outer peripheral edge 104B also extends along the direction intersecting (orthogonal to) the transport direction of the sheet P.

The first lateral outer peripheral edge 104C is the outer peripheral edge 104 connecting one end of the front-end outer peripheral edge 104A and one end of the rear-end outer peripheral edge 104B. The first lateral outer peripheral edge 104C extends along the transport direction of the sheet P.

The second lateral outer peripheral edge 104D is the outer peripheral edge 104 connecting the other end of the leading-end outer peripheral edge 104A and the other end of the rear-end outer peripheral edge 104B. The second lateral outer peripheral edge 104D also extends along the transport direction of the sheet P.

When the sheet P is suctioned, as indicated by a reference sign 5A in FIG. 5, the device body 101 of the suction unit 100 is located inside the outer peripheral edge 104 of the sheet bundle 54.

Then, when the sheet P is supplied to the most-upstream transport roller 52E, as indicated by an arrow 2B, the suction unit 100 moves toward the most-upstream transport roller 52E.

Furthermore, in the present exemplary embodiment, as illustrated in FIG. 5, the lateral blowing device 400 is provided laterally of the storage unit 53.

In the present exemplary embodiment, the lateral blowing device 400 is provided at a position opposite the second lateral outer peripheral edge 104D of the sheet bundle 54 stored in the storage unit 53.

In the present exemplary embodiment, the sheet bundle 54 has a cuboidal shape and has four side surfaces, and the lateral blowing device 400 is provided at a position opposite one of the four side surfaces.

Specifically, the lateral blowing device 400 is provided at a position opposite one side surface among the four side surfaces that, as indicated by a reference sign 4Z, is along the feeding direction of the sheet P fed from the sheet storage device 200.

The installation location of the lateral blowing device 400 is not limited to the above. The lateral blowing device 400 may be provided at a position opposite the first lateral outer peripheral edge 104C; at a position opposite the leading-end lateral outer peripheral edge 104A; or at a position opposite the rear-end lateral outer peripheral edge 104B, for example.

In other words, the lateral blowing device 400 may be provided at a position opposite any of the above-described four side surfaces other than the one side surface indicated by reference sign 4Z.

Further, the sheet bundle 54 may have not just one but two or more blown positions to which the gas is blown by the lateral blowing device 400.

The lateral blowing device 400 is provided with: a gas supply source (not illustrated), such as a fan; an ejection port 4X from which gas from the gas supply source is ejected; and a flow path 4Y that connects the gas supply source and the ejection port 4X.

The number of the ejection ports 4X is not particularly limited, and may be one or more. When the number of the ejection ports 4X is two or more, the number of the blown positions of the sheet bundle 54 to which the gas is blown by the lateral blowing device 400 will be two or more.

In the present exemplary embodiment, the gas is sent from the ejection port 4X toward the side surface of the sheet bundle 54, and is blown onto the side surface. When the gas is blown onto the side surface of the sheet bundle 54, the gas enters between the sheets P constituting the sheet bundle 54, and each of the sheets P floats.

Each of the drive roller 52A and the driven roller 52B provided in the most-upstream transport roller 52E is a rotating member, and rotates to transport the sheet P from the storage unit 53 to the downstream side. The drive roller 52A and the driven roller 52B are provided on the downstream side in the transport direction of the sheet P with respect to the storage unit 53.

Each of the drive roller 52A and the driven roller 52B provided in the most-upstream transport roller 52E includes a rotation shaft 52X and a plurality of cylindrical members 52Y attached around the rotation shaft 52X.

In the present exemplary embodiment, when the suction unit 100 moves toward the most-upstream transport roller 52E, the suction unit 100 is configured to enter between the two cylindrical members 52Y. Thus, no interference is caused between the suction unit 100 and the most-upstream transport roller 52E.

The configuration of the suction unit 100 will be further described with reference to FIG. 4.

The suction unit 100 is provided with the device body 101, as described above. An air guide member 120 that guides a gas ejected from a leading-end blowing device 150 (to be described later) is attached to the device body 101.

The air guide member 120 is provided with an uneven portion 121 for imparting a wavy shape to the leading-end edge portion 2G (see FIG. 5) of the sheet P.

The uneven portion 121 is disposed to extend in a direction orthogonal to the transport direction of the sheet P. Specifically, the uneven part 121 is disposed to extend along the leading-end edge portion 2G of the sheet P.

In the present exemplary embodiment, when the sheet P is attracted to the lower surface 101X of the device body 101, the leading-end edge portion 2G of the sheet P is pressed against the uneven portion 121, whereby the wavy shape is imparted to the leading-end edge portion 2G.

Further, in the present exemplary embodiment, a suction opening 122 for further performing suction of the sheet P attached to the lower surface 101X is provided closer to the lower surface 101X horizontally than the uneven portion 121.

Further, the air guide member 120 is provided with an air guide portion 123 that guides the gas to be blown onto the leading-end edge portion 2G (see FIG. 5).

The air guide portion 123 is formed with a concave portion 124 which is upwardly convex.

More specifically, the upwardly convex concave portion 124 is formed in a lower surface 123A of the air guide portion 123. The concave portion 124 is formed in a groove shape. The concave portion 124 is provided along a direction in which the leading-end edge portion 2G of the sheet P (see FIG. 5) extends.

In the present exemplary embodiment, as illustrated in FIG. 5, a rectangular opening 125 is formed in the lower surface 123A of the air guide portion 123 (see FIG. 4). As illustrated in FIG. 4, the upwardly convex concave portion 124 is provided higher than the opening 125. Here, “above” the opening 125 means above in the vertical direction.

In the present exemplary embodiment, as illustrated in FIG. 5, an opening edge 126 surrounding the opening 125 is present around the same. The opening edge 126 is formed in a rectangular shape.

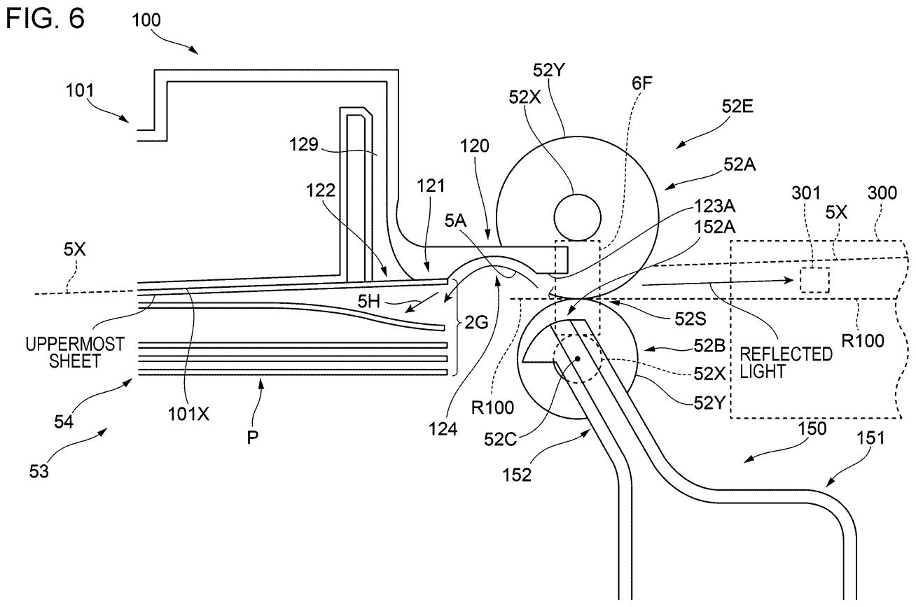

FIG. 6 is a diagram of the suction unit 100 and the leading-end blowing device 150 when viewed from the side of the sheet bundle 54. In other words, FIG. 6 is a diagram of the suction unit 100 and the leading-end blowing device 150 when viewed from a position facing the side surface of the sheet bundle 54 along the feeding direction of the sheet P.

In the present exemplary embodiment, in addition to the lateral blowing device 400 (not illustrated in FIG. 6) described above, as illustrated in FIG. 6, the leading-end blowing device 150 that blows a gas onto the leading-end edge portion 2G of the sheet P is provided.

The leading-end blowing device 150 as another example of the blowing unit is provided with a gas supply source 151, such as a fan, and a pipe 152 for guiding air fed by the gas supply source 151 obliquely upward.

The leading-end blowing device 150 blows air, which is an example of gas, onto the sheets P stored in the storage unit 53. The gas blown onto the sheets P by the leading-end blowing device 150 is not limited to air, and may be another type of gas.

The leading-end blowing device 150 blows gas onto a portion of the sheets P stored in the storage unit 53, the portion being located on the downstream side in the transport direction of the sheet P. More specifically, the leading-end blowing device 150 blows gas onto the leading-end edge portion 2G of the sheets P stored in the storage unit 53.

The gas supply source 151 and the pipe 152 provided in the leading-end blowing device 150 are located lower than the lower surface 101X of the device body 101.

At the tip-end part of the pipe 152, an ejection port 152A is provided. The ejection port 152A ejects the air moving toward the concave portion 124 provided in the air guide member 120.

In the present exemplary embodiment, as indicated by an arrow 5A, the gas from the ejection port 152A moves upward above the lower surface 101X. Thereafter, the gas moves downward and is blown onto the leading-end edge portion 2G from above the lower surface 101X.

In the present exemplary embodiment, the gas from the lower side of an extension surface 5X of the lower surface 101X moves upward above the extension surface 5X. Thereafter, the gas moves downward below the extension surface 5X, and is then blown onto the leading-end edge portion 2G.

In the present exemplary embodiment, the gas from the gas supply source 151 is guided by the tube 152 to move upward once, and then the gas moves downward. Then, in the present exemplary embodiment, the gas directed downward is blown onto the leading-end edge portion 2G of the sheets P.

In the present exemplary embodiment, the gas supplied from below the lower surface 101X of the device body 101 is guided by the concave portion 124 provided in the air guiding member 120 to flow downward. Then, the air directed downward is blown onto the leading-end edge portion 2G of the sheet P.

In the present exemplary embodiment, the ejection port 152A is provided lower than a contact portion 52S between the drive roller 52A and the driven roller 52B that are provided in the most-upstream transport roller 52E.

In the present exemplary embodiment, the gas that has passed through the tube 152 is ejected from the ejection port 152A located at the tip-end of the tube 152. The ejection port 152A is located lower than the contact portion 52S between the drive roller 52A and the driven roller 52B.

In the present exemplary embodiment, the tube 152 that guides the upward-moving gas is configured not to cross the transport path R100 of the sheet P. In the present exemplary embodiment, the ejection port 152A of the tube 152 is located lower than the transport path R100 of the sheet P. Thus, in the present exemplary embodiment, only the gas crosses the transport path R100 of the sheet P.

The gas that has crossed the transport path R100 moves toward the concave portion 124. Then, the gas is guided by the concave portion 124, and the guided gas is blown onto the leading-end edge portion 2G.

When the gas is blown onto the leading edge portion 2G from the upper side, in the present exemplary embodiment, the gas is sent obliquely downward as indicated by an arrow 5H, and the gas sent obliquely downward is blown onto the leading-end edge portion 2G.

More particularly, in the present exemplary embodiment, the gas is sent obliquely downward from above the leading edge portion 2G of the sheet P attracted to the lower surface 101X and from the side away from the leading edge portion 2G, and the gas is then blown onto the leading-end edge portion 2G.

In this way, when the gas is sent obliquely downward as indicated by the arrow 5H, compared to if the gas is sent directly downward, the gas easily enters between the sheets P, and the second and any subsequent sheet P attached to the uppermost sheet P attracted to the lower surface 101X are easily separated from the uppermost sheet P.

In FIG. 6, the imaging mechanism 300 is also illustrated.

The imaging mechanism 300 is disposed on the downstream side of the most-upstream transport roller 52E in the transport direction of the sheet P. The imaging mechanism 300 images the sheets P in a state of being blown with the gas, from the downstream side of the most-upstream transport roller 52E.

More specifically, the imaging mechanism 300 images the sheets P located in an upper part of the sheet bundle 54 among the sheets P constituting the sheet bundle 54.

In the present exemplary embodiment, in the driven rollers 52B provided in the most-upstream transport roller 52E (refer to FIG. 6), the rotation shaft 52X of the driven rollers 52B is individually provided for each of the two cylindrical members 52Y. Thus, two rotation shafts 52X are provided in the driven rollers 52B.

In the present exemplary embodiment, the pipe 152 provided as a part of the leading-end blowing device 150 is provided in the gap between the two rotation shafts 52X, so that the leading-end blowing device 150 and the driven rollers 52B do not interfere with each other.

In the present exemplary embodiment, when the sheets P stacked in the storage unit 53 are to be transported, first, as illustrated in FIGS. 3A and 3B, the uppermost one of the sheets P in a floating state is attracted to the suction unit 100.

Further, as indicated by an arrow 2F in FIG. 3B, the leading-end blowing device 150 (not illustrated in FIG. 3B) is used to send the gas obliquely downward from above the leading-end edge portion 2G of the sheet P, to blow the gas onto the leading edge portion 2G.

At this time, in the present exemplary embodiment, the sheet P is imaged using the imaging mechanism 300 to obtain a captured image. Then, the CPU 11a analyzes the captured image and determines whether or not an overlap is present between the first sheet P located at the top and the second sheet P located under the first sheet P.

Next, if it is determined that there is an overlap, the CPU 11a changes the output of the lateral blowing device 400 as described above. On the other hand, if it is determined that there is no overlap, CPU 11a outputs a control signal for starting the transport of the sheet P.

Besides, if it is determined that there is an overlap, the CPU 11a may interrupt the transport of the sheet P, and notify, via the UI 70 (see FIG. 1), the user that the condition is prone to double feeding.

When a control signal for starting the transport of the sheet P is output, as illustrated in FIG. 3C, the suction unit 100 moves toward the most-upstream transport roller 52E, and the sheet P attracted to the suction unit 100 is supplied to the most-upstream transport roller 52E.

Note that in the present exemplary embodiment, the suction unit 100 is not moved vertically when the sheet P is attracted by the suction unit 100. However, this is not a limitation, and the suction unit 100 may be lowered when the sheet P is taken out, and the suction unit 100 may be raised when the sheet P has adhered to the suction unit 100.

When the adhesion force between the sheets P is large, the second sheet P located below may adhere to the uppermost first sheet P attracted to the suction unit 100. In this case, a plurality of sheets P are supplied to the most-upstream transport roller 52E, resulting in the so-called double feeding.

In the present exemplary embodiment, in order to suppress the occurrence of the double feeding, as described above, the gas is blown onto the leading-end edge portion 2G from the upper side. In this way, the second or any subsequent sheet P adhering to the uppermost first sheet P can be easily separated from the uppermost first sheet P.

Further, in the present exemplary embodiment, in order to further suppress the attraction between the sheets P, the lateral blowing device 400 illustrated in FIGS. 1 and 5 is used to blow gas onto the side surface of the sheet bundle 54 from laterally of the sheet bundle 54.

When the gas is blown onto the side surface of the sheet bundle 54, the gas enters between the sheets P, and the attraction between the sheets P is reduced. In the present exemplary embodiment, when the gas is blown onto the side surface of the sheet bundle 54, the air enters between the sheets P, and each of the sheets P floats.

In the present exemplary embodiment, also when the suction unit 100 moves toward the most-upstream transport roller 52E, the blowing of gas by the lateral blowing device 400 and the leading-end blowing device 150 is performed.

The present exemplary embodiment is configured such that the blowing of the gas onto the sheet bundle 54 is constantly performed. Also when the suction unit 100 is moved, the blowing of the gas by the lateral blowing device 400 and the leading-end blowing device 150 is performed.

This, however, is not a limitation. When the suction unit 100 moves toward the most-upstream transport roller 52E, the blowing of gas by the leading-end blowing device 150 may be stopped, or the amount of gas supplied by the leading-end blowing device 150 may be reduced.

Referring to FIG. 4, the suction unit 100 will be further described.

As described above, in the present exemplary embodiment, the suction opening 122 for further performing suction of the sheet P adhering to the lower surface 101X is provided horizontally closer to the lower surface 101X than the uneven portion 121.

In the present exemplary embodiment, when the sheet P is in a state of being attracted to the lower surface 101X, suctioning of the sheet P by the suction opening 122 is started.

In the present exemplary embodiment, as illustrated in FIG. 4, a connection path 129 that connects the suction opening 122 and the inside of the device body 101 is provided, and the inside of the connection path 129 is depressurized. As illustrated in FIG. 4, the connection path 129 is formed such that the width thereof (width in the direction in which the leading-end edge portion 2G (see FIG. 5) extends) gradually increases toward the lower side.

In the present exemplary embodiment, before the sheet P adheres to the lower surface 101X, a clearance is formed between the sheet P and the suction opening 122 and suction of the sheet P by the suction opening 122 is not performed.

Next, when the sheet P is attracted to the lower surface 101X, the clearance between the sheet P and the suction opening 122 disappears, and the sheet P is suctioned by the suction opening 122.

Next, when the sheet P is suctioned by the suction opening 122, the leading-end edge portion 2G of the sheet P is biased toward the uneven portion 121 and pressed against the uneven portion 121.

As a result, an uneven shape is imparted to the leading-end edge portion 2G. In other words, a wavy shape is imparted to the leading-end edge portion 2G.

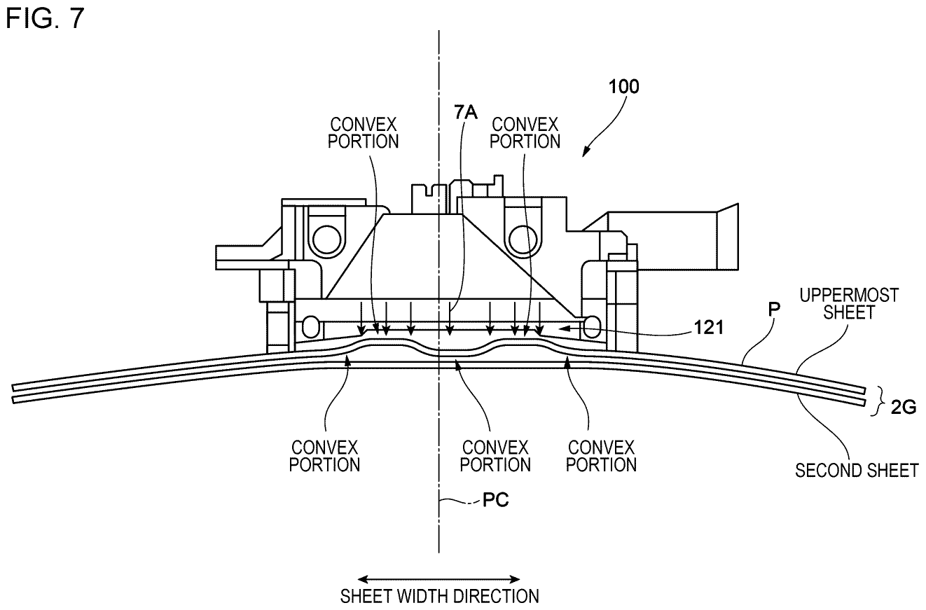

FIG. 7 is a view of the suction unit 100 as viewed from the direction of an arrow VII in FIG. 3B.

In the present exemplary embodiment, as indicated by an arrow 7A, the gas is blown onto the leading edge portion 2G from the upper side of the leading edge portion 2G. The gas is blown onto the part of the leading edge portion 2G to which the wavy shape is imparted.

In the present exemplary embodiment, as described above, the leading-end edge portion 2G of the sheet P is pressed against the uneven portion 121. Thus, a wavy shape is imparted to the leading-end edge portion 2G of the sheet P.

In the present exemplary embodiment, a gas is blown from above onto the portion to which the wavy shape is imparted.

Accordingly, compared to if the gas is blown onto a part of the sheet P to which the wavy shape is not imparted, the air easily enters between the uppermost first sheet P attracted to the suction unit 100 and the second sheet P adhering to the first sheet P.

In this case, the second sheet P is easily separated from the uppermost sheet P that is the first sheet P.

Here, the “wavy shape” means a shape in which one convex portion protruding from one surface side of the sheet P toward the other surface side in the thickness direction of the sheet P, and another convex portion protruding from the other surface side of the sheet P toward the one surface side in the thickness direction of the sheet P are alternately arranged in the direction in which the leading-end edge portion 2G extends.

Here, the number of the one convex portion and the other convex portion is not particularly limited. A state in which one convex portion and one other convex portion are provided and disposed adjacent to each other can also be referred to as a state in which the waveform shape is imparted.

In another manner of implementation, the gas may be directly blown onto the leading-end edge portion 2G from above.

In the above description, the gas from the gas supply source 151 located below is once moved upward, moved downward, and then blown onto the leading-end edge 2G from above. However, the manner of implementation of the blowing is not limited to the above.

For example, a gas supply source, such as a fan, may be provided higher than the lower surface 101X of the device body 101, and the gas may be directly supplied to the leading-end edge portion 2G from above.

In the present exemplary embodiment, as illustrated in FIG. 6, the imaging mechanism 300 is disposed on the downstream side of the storage unit 53 in the transport direction of the sheet P, and is disposed on the downstream side of the drive rollers 52A and the driven rollers 52B provided in the most-upstream transport roller 52E in the transport direction of the sheet P.

The drive roller 52A and the driven roller 52B illustrated in FIG. 6 are rotating members. In the present exemplary embodiment, the imaging mechanism 300 is provided on the downstream side, in the transport direction of the sheet P, of the rotation shaft 52X provided in each of the drive roller 52A and the driven roller 52B, which are examples of a rotating member.

The imaging mechanism 300 illustrated in FIG. 6 images the sheets P stored in the storage unit 53 in a state of being blown with the gas, through a space indicated by a reference sign 6F.

When the drive roller 52A and the driven roller 52B are viewed from the front side of the sheet of FIG. 6, the space indicated by the reference sign 6F is located between the rotation shafts 52X provided in the drive roller 52A and the driven roller 52B.

In other words, when the drive roller 52A and the driven roller 52B are viewed on an extension line 52C of the rotation shaft 52X provided in the driven roller 52B, the space indicated by the reference sign 6F is located between the rotation shafts 52X provided in the drive roller 52A and the driven roller 52B.

Further, the space indicated by the reference sign 6F in FIG. 6 is located between the two cylindrical members 52Y (see also FIG. 5) each comprising the drive roller 52A and the driven roller 52B.

Each of the drive roller 52A and the driven roller 52B is provided with the rotation shaft 52X. The space indicated by the reference sign 6F in FIG. 6 is located between the two cylindrical members 52Y located at different positions in the axis direction of the rotation shaft 52X.

In the present exemplary embodiment, light reflected from the sheets P passes through the space indicated by the reference sign 6F in FIG. 6, and is directed to a light receiving unit 301 provided in the imaging mechanism 300.

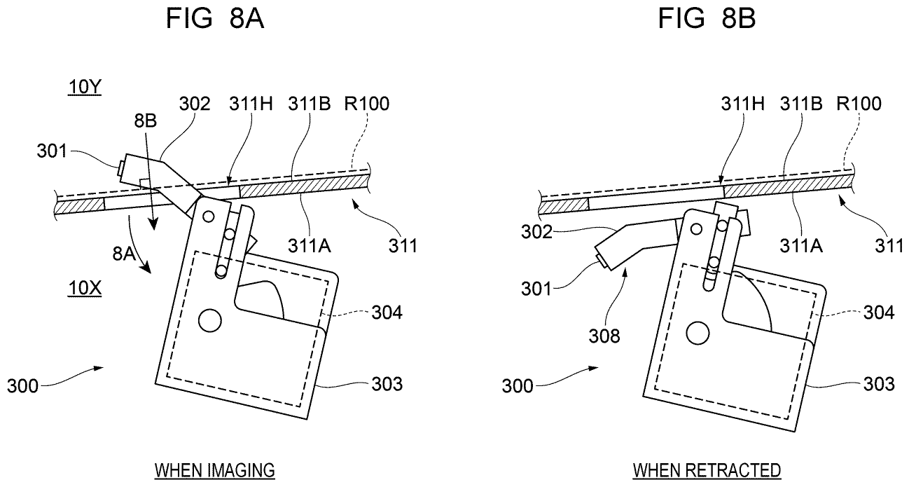

FIGS. 8A and 8B illustrate the imaging mechanism 300.

As illustrated in FIG. 8A, the imaging mechanism 300 includes the light receiving unit 301, a support unit 302 that supports the light receiving unit 301, and a body unit 303 that supports the support unit 302. The body unit 303 is provided with a moving mechanism 304 that moves the support unit 302.

When the sheet P (not illustrated in FIGS. 8A and 8B) is imaged by the imaging mechanism 300, a part of the imaging mechanism 300 is located on the transport path R100 of the sheet P, as illustrated in FIG. 8A. Specifically, in the present exemplary embodiment, the support unit 302 that supports the light receiving unit 301 is located on the transport path R100.

Further, in the present exemplary embodiment, when the imaging mechanism 300 images the sheets P, as illustrated in FIG. 8A, the light receiving unit 301 is located on the side opposite to the side where the body unit 303 of the imaging mechanism 300 is located, with the transport path R100 interposed therebetween.

In the present exemplary embodiment, when the sheet P is imaged by the imaging mechanism 300, the body unit 303 of the imaging mechanism 300 is located on one side 10X of the transport path R100, and the light receiving unit 301 of the imaging mechanism 300 is located on the other side 10Y of the transport path R100.

In the present exemplary embodiment, the part of the imaging mechanism 300 located on the transport path R100 of the sheet P is movable in a direction separating from the transport path R100 of the sheet P. In the present exemplary embodiment, the part of the imaging mechanism 300 is the support unit 302. The support unit 302 is movable in a direction indicated by an arrow 8A.

In addition, in the present exemplary embodiment, the light receiving unit 301 also moves along with the movement of the support unit 302. The light receiving unit 301, being supported by the support unit 302, also moves in the direction separating from the transport path R100 of the sheet P.

After the sheets P are imaged by the imaging mechanism 300, in the present exemplary embodiment, the support unit 302 that has been located on the transport path R100 and the light receiving unit 301 supported by the support unit 302 move in the direction separating from the transport path R100, in response to a control signal from the CPU 11a, as illustrated in FIG. 8B.

Thus, as illustrated in FIG. 8B, the support unit 302 and the light receiving unit 301 come to be located at a position away from the transport path R100.

In the present exemplary embodiment, after the sheets P are imaged by the imaging mechanism 300, the light receiving unit 301 that has been located on the side away from the body unit 303 moves to the side where the body unit 303 is located, as illustrated in FIG. 8B.

In the present exemplary embodiment, after the sheets P are imaged by the imaging mechanism 300, the support unit 302 that has been located on the transport path R100 and the light receiving unit 301 supported by the support unit 302 are retracted from the transport path R100, as illustrated in FIG. 8B.

In the present exemplary embodiment, when the sheets P are imaged by the imaging mechanism 300, the support unit 302 is located on the transport path R100, as illustrated in FIG. 8A. However, the light receiving unit 301 may be configured to be located on the transport path R100.

In the present exemplary embodiment, when the light receiving unit 301 and the support unit 302 move in the direction separating from the transport path R100, the light receiving unit 301 and the support unit 302 move in the direction indicated by the arrow 8A in FIG. 8A.

During this movement, the light receiving unit 301 and the support unit 302 first move so as to cross the transport path R100, and then move away from the transport path R100.

Thereafter, as illustrated in FIG. 8B, the light receiving unit 301 and the support unit 302 are stopped at a location away from the transport path R100.

When transport of the sheet P from the storage unit 53 (not illustrated in FIGS. 8A and 8B) is performed, the light receiving unit 301 and the support unit 302 are disposed in the state illustrated in FIG. 8B. In FIG. 8B, the light receiving unit 301 and the support unit 302 are in a state of being stopped at a retracted position 308 located away from the transport path R100.

In the state where the light receiving unit 301 and the support unit 302 are stopped at the retracted position 308, as illustrated in FIG. 8B, the light receiving unit 301 and the support unit 302 are located on the back surface 311A side of the sheet guide member 311.

Thus, the transported sheet P is less likely to be caught by the imaging mechanism 300, compared to a configuration in which the light receiving unit 301 and the support unit 302 are located on the side of the 311B of the sheet guide member 311.

The sheet guide member 311 is disposed lower than the transport path R100 of the sheet P, and is provided along the transport path R100. The sheet guide member 311 supports the transported sheet P from below and guides the sheet P so that the sheet P moves along the transport path R100.

As illustrated in FIG. 8A, the sheet guide member 311 is provided with an opening 311H that connects a front surface 311B side and a back surface 311A side of the sheet guide member 311. The light receiving unit 301 and the support unit 302 move toward the transport path R100 or toward the retracted position 308 through the opening 311H.

As illustrated in FIG. 8A, the body unit 303 of the imaging mechanism 300 is provided on the back surface 311A side of the sheet guide member 311. Further, as illustrated in FIG. 8B, the retracted position 308 is provided on the back surface 311A side of the sheet guide member 311 in the present exemplary embodiment.

When imaging of the sheet P is performed, the light receiving unit 301 and the support unit 302 that have been located at the retracted position 308 pass through the opening 311H and move toward the transport path R100, as illustrated in FIG. 8A.

When the imaging of the sheet P is completed, the light receiving unit 301 and the support unit 302 pass through the opening 311H and move to the retracted position 308, as illustrated in FIG. 8B.

When moving to the retracted position 308 located on the back surface 311A side of the sheet guide member 311, the light receiving unit 301 and the support unit 302 move in the thickness direction of the sheet P transported on the transport path R100. In other words, the light receiving unit 301 and the support unit 302, when moving in the direction separating from the transport path R100, move in the thickness direction of the sheet P transported on the transport path R100.

The direction indicated by an arrow 8B in FIG. 8A indicates the thickness direction of the sheet P. The light receiving unit 301 and the support unit 302 move in the direction indicated by the arrow 8B when moving to the retracted position 308 located on the back surface 311A side of the sheet guide member 311.

In other words, the light receiving unit 301 and the support unit 302 move in the thickness direction of the sheet P when moving in the direction separating from the transport path R100.

The direction in which the light receiving unit 301 and the support unit 302 move in the direction separating from the transport path R100 is not limited to the thickness direction of the sheet P transported on the transport path R100. The direction may be a direction orthogonal to the transport direction of the sheet P and the width direction of the sheet P.

In the present exemplary embodiment, the light receiving unit 301 and the support unit 302, which are moving parts of the imaging mechanism 300, are provided at a position opposite the center portion in the width direction of the sheet P to be transported.

In this case, when the light receiving unit 301 and the support unit 302 are configured to move in the thickness direction of the sheet P as in the present exemplary embodiment, the moving distance of the light receiving unit 301 and the support unit 302 is shorter than in a configuration in which they move in the width direction of the sheet P.

In this case, the retraction of the light receiving unit 301 and the support unit 302 in the direction separating from the transport path R100 can be performed in a shorter time.

In the present exemplary embodiment, the light receiving unit 301 and the support unit 302, which are moving parts of the imaging mechanism 300, are provided at a position opposite the center portion in the width direction of the sheet P to be transported.

Specifically, with reference to FIG. 5, the light receiving unit 301 and the support unit 302 of the imaging mechanism 300 are provided at a position indicated by a reference sign 5G in FIG. 5.

When the light receiving unit 301 and the support unit 302 are provided at the position indicated by the reference sign 5G in FIG. 5, the light receiving unit 301 and the support unit 302 are located opposite the central portion in the width direction of the sheet P when retracted and located at the position opposite one surface of the sheet P being transported.

In this case, when the light receiving unit 301 and the support unit 302 are configured to be moved in the thickness direction of the sheet P, the amount of movement of the light receiving unit 301 and the support unit 302 required to retract the light receiving unit 301 and the support unit 302 from the transport path R100 is reduced, compared to when configured to be moved in the width direction of the sheet P.

In this case, the retraction of the light receiving unit 301 and the support unit 302 from the transport path R100 can be completed in a shorter time.

In FIG. 5, the width direction of the sheet P is indicated by an arrow 5H.

Furthermore, in the present exemplary embodiment, it is possible to reduce the manufacturing cost of the image forming apparatus 1.

The imaging mechanism 300 may be provided at two positions, for example, one indicated by reference sign 5J and the other indicated by reference sign 5K in FIG. 5. The imaging mechanisms 300 provided at the two positions may be used to perform imaging of the leading-end edge portion 2G of the sheet P. Incidentally, in this case, the two imaging mechanisms 300 will increase the manufacturing cost of the image forming apparatus 1.

In contrast, the present exemplary embodiment is configured such that one imaging mechanism 300 is provided on the downstream side of the storage unit 53. Thus, the manufacturing cost of the image forming apparatus 1 is lower than in the configuration in which two imaging mechanisms 300 are provided.

Here, when the imaging mechanism 300 is provided on the downstream side of the storage unit 53 as in the present exemplary embodiment, the sheet P transported from the storage unit 53 and the imaging mechanism 300 are likely to interfere with each other. However, in the present exemplary embodiment, as described above, the light receiving unit 301 and the support unit 302 are configured to be retracted, so that no interference occurs between the transported sheet P and the imaging mechanism 300.

In the configuration example illustrated in FIGS. 8A and 8B, the body unit 303 of the imaging mechanism 300 is provided below the transport path R100. However, the body unit 303 of the imaging mechanism 300 may be provided above the transport path R100.

In other words, in the configuration example illustrated in FIGS. 8A and 8B, while the body unit 303 of the imaging mechanism 300 is provided on one side 10X of the transport path R100, the body unit 303 of the imaging mechanism 300 may be provided on the other side 10Y of the transport path R100.

When the body unit 303 of the imaging mechanism 300 is provided above the transport path R100, the light receiving unit 301 and the support unit 302 move downward from above to approach the transport path R100.

Furthermore, when the body unit 303 of the imaging mechanism 300 is provided above the transport path R100, the light receiving unit 301 and the support unit 302 move upward from below to be retracted from the transport path R100.

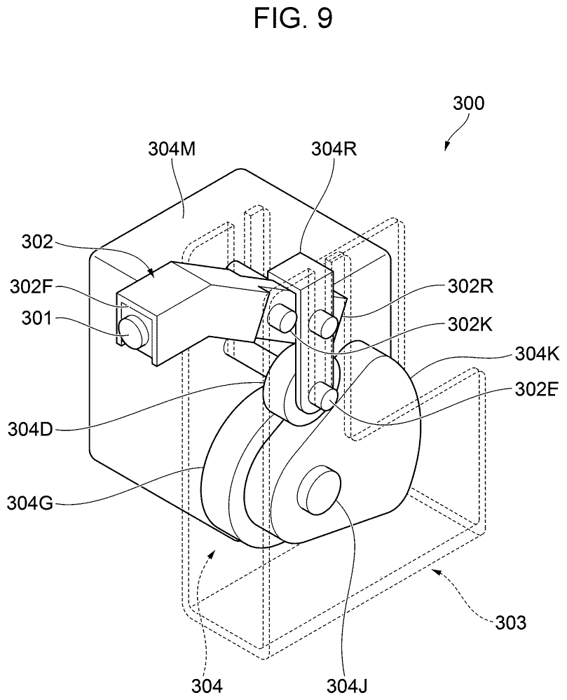

FIG. 9 is a perspective view illustrating the internal configuration of the imaging mechanism 300.

In the present exemplary embodiment, as described above, the moving mechanism 304 that moves the support unit 302 is provided in the body unit 303 of the imaging mechanism 300.

The moving mechanism 304 is provided with a motor 304M; a rotary gear 304G that rotates by receiving a driving force from a gear (not illustrated) attached to the output shaft of the motor 304M; and a rotary cam 304K attached to a shaft 304J that rotates in conjunction with the rotary gear 304G. The rotary cam 304K rotates by receiving a driving force from the shaft 304J.

Further, the moving mechanism 304 is provided with a moving body 304D which is disposed above the rotary cam 304K and is vertically moved by being pressed by the outer peripheral surface of the rotary cam 304K. The movable body 304D is rotatable about a shaft 304E formed in a cylindrical shape and disposed horizontally.

Furthermore, the moving mechanism 304 is provided with an interlocking member 304R that extends upward in the drawing from the moving body 304D and moves vertically in conjunction with the vertical movement of the moving body 304D. The interlocking member 304R is fixed to a right end portion 302R of the support unit 302.

The support unit 302 is rotatably supported by a support shaft 302K supported by the body unit 303 of the imaging mechanism 300.

As the interlocking member 304R moves vertically, the support unit 302 rotates around the support shaft 302K, and the left end portion 302F of the support unit 302 moves vertically correspondingly. As the left end portion 302F of the support unit 302 moves vertically, the light receiving unit 301 attached to the left end portion 302F moves vertically.

In the present exemplary embodiment, by the vertical movement of the light receiving unit 301, as illustrated in FIGS. 8A and 8B, the light receiving unit 301 moves toward the transport path R100, and moves toward the body unit 303 of the imaging mechanism 300.

In the present exemplary embodiment, the rotating cam 304K is rotated in one direction by more than 360°.

In the present exemplary embodiment, the rotary cam 304K can be rotated in both one direction and the opposite direction. However, in the present exemplary embodiment, the rotary cam 304K is rotated only in one direction.

When the rotating cam 304K is rotated only in one direction, the movement of the light receiving unit 301 toward the transport path R100 and the movement of the light receiving unit 301 toward the body unit 303 can be performed in a shorter time.

When the rotating cam 304K is rotated only in one direction, the light receiving unit 301 can be moved in a shorter time than when the rotating cam 304K is rotated in one direction and in the opposite direction to move the light receiving unit 301.

The moving mechanism 304 of the imaging mechanism 300 is not limited to the mechanism using a cam, and may comprise another mechanism. For example, a rack and pinion mechanism may be used to move the light receiving unit 301. Alternatively, a solenoid may be used to move the light receiving unit 301.

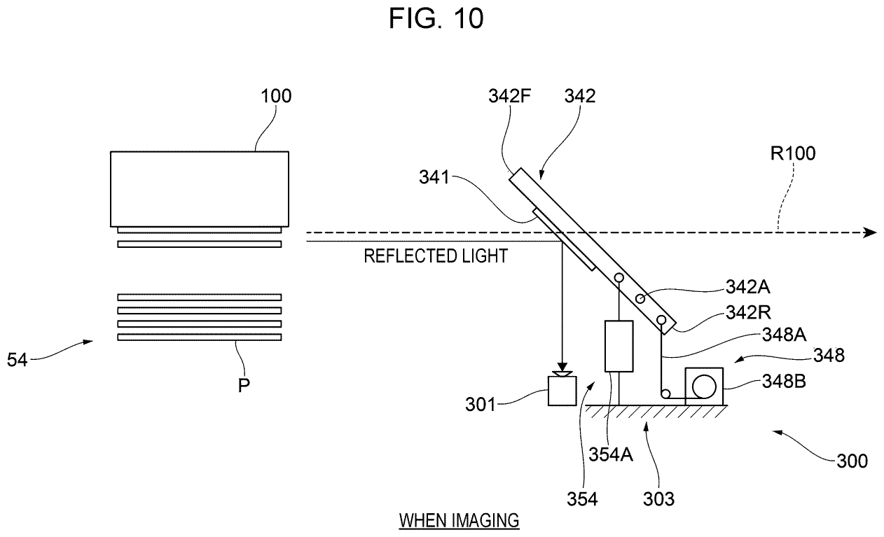

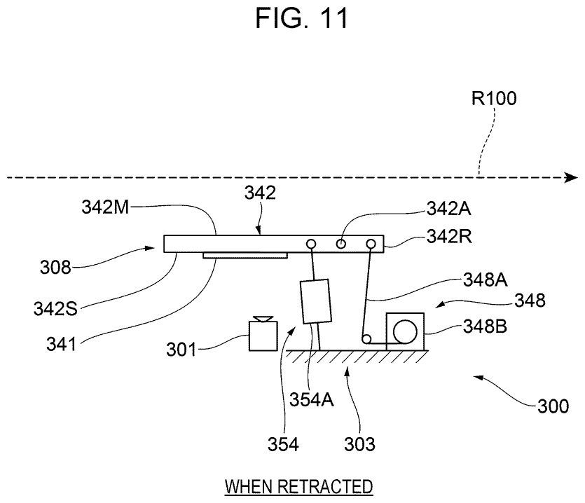

FIGS. 10 and 11 are diagrams illustrating other configuration examples of the imaging mechanism 300.

Also in this configuration example, as illustrated in FIG. 10, the light receiving unit 301 for receiving reflected light from the sheet P is provided, similarly to the above. Note that in this configuration example, the light receiving unit 301 is not moved. Furthermore, in this configuration example, the light receiving unit 301 is provided at a position away from the transport path R100 of the sheet P.

In addition, in this configuration example, a light reflecting unit 341 for guiding the reflected light from the sheet P to the light receiving unit 301, and a support unit 342 for supporting the light reflecting unit 341 are provided.

The light reflecting unit 341 is a mirror and reflects the reflected light from the sheet P to guide the reflected light to the light receiving unit 301.

Also in this configuration example, the support unit 342 is movable.

More specifically, the support unit 342 is configured to rotate about a rotation shaft 342A. The rotation moves a left end portion 342F and a right end portion 342R of the support unit 342, which is formed in a plate shape.

The left end portion 342F of the support unit 342 is located on the upstream side of the right end portion 342R in the transport direction of the sheet P.

In this configuration example, when the sheet P is imaged, the support unit 342 and the light reflecting unit 341 are located on the transport path R100 of the sheet P, as illustrated in FIG. 10. In this configuration example, the reflected light from the sheet P is reflected by the light reflecting unit 341 and travels toward the light receiving unit 301. Thus, a captured image of the sheet P can be obtained.

Also in this configuration example, the support unit 342 and the light reflecting unit 341 move in the direction separating from the transport path R100 when performing retraction. In this configuration example, the support unit 342 and the light reflecting unit 341, which are part of the imaging mechanism 300, move in the direction separating from the transport path R100 of the sheet P.

When the support unit 342 and the light reflecting unit 341 move in the direction separating from the transport path R100 of the sheet P, the imaging mechanism 300 enters the state illustrated in FIG. 11.

In this configuration example, when the sheet P is imaged, the light reflecting unit 341 and the support unit 342 are disposed so as to cross the transport path R100, as illustrated in FIG. 10.

When the light reflecting unit 341 and the support unit 342 are retracted, the support unit 342 rotates in a counterclockwise direction in the drawing, and the left end portion 302F of the support unit 342 moves downward in the drawing. Accordingly, the left end portion 302F of the support unit 342 and the light reflecting unit 341 move in the direction separating from the transport path R100.

Then, finally, as illustrated in FIG. 11, the light reflecting unit 341 and the support unit 342 are located at a position away from the transport path R100. In other words, also in this case, the light reflecting unit 341 and the support unit 342 are located at the predetermined retracted position 308.

In this configuration example, when the support unit 342 that supports the light reflecting unit 341 is located at the retracted position 308, as illustrated in FIG. 11, one surface 342M of the support unit 342 faces the transport path R100, and extends along the transport path R100.

In this configuration example, among the surfaces of the support unit 342, the one surface 342M located on the opposite side to the support surface 342S supporting the light reflecting unit 341 faces the transport path R100 and extends along the transport path R100.

In this case, the sheet P passing through the transport path R100 is guided by the one surface 342M of the support unit 342 and moves to the downstream side. The one surface 342M serves as a guide surface for guiding the sheet P.

The configuration of the body unit 303 of the imaging mechanism 300 will be described with reference to FIG. 10.

The body unit 303 is provided with a moving mechanism 354 that moves the support unit 342.

In the present exemplary embodiment, as the moving mechanism 354, a spring 354A as an example of an urging member is provided to urge the left end portion 342F side of the support unit 342.

The support unit 342 is provided so as to be rotatable about a rotation shaft 342A. In the configuration example illustrated in FIG. 10, a portion of the support unit 342 located on the left side of the rotation shaft 342A is biased by the spring 354A in the direction separating from the transport path R100.

In the present exemplary embodiment, the biasing causes the left end portion 342F side of the support unit 342 and the light reflecting unit 341 to move in the direction separating from the transport path R100.

Further, in this configuration example, a pulling mechanism 348 that pulls the right end portion 342R side of the support unit 342 in the direction separating from the transport path R100 is provided.

In this configuration example, the pulling mechanism 348 causes the right end portion 342R side of the support unit 342 to move in the direction separating from the transport path R100 of the sheet P.

When the right end portion 342R side of the support unit 342 moves in the direction separating from the transport path R100 of the sheet P, the support unit 342 rotates about the rotation shaft 342A in a clockwise direction in the drawing. In response, the light reflecting unit 341, which is attached to the portion of the support unit 342 that is positioned on the left end portion 302F side with respect to the rotation shaft 342A, approaches the transport path R100.

The pulling mechanism 348 is composed of a wire 348A attached to the right end portion 342R of the support unit 342, and a winding mechanism 348B for winding the wire 348A.

In this configuration example, by winding the wire 348A with the winding mechanism 348B, the right end portion 302R of the support unit 342 moves, and, accordingly, the left end portion 302F of the support unit 342 and the light reflecting unit 341 approach the transport path R100.

On the other hand, when the wire 348A is unwound, the left end portion 302F side of the support unit 342 moves due to the biasing by the spring 354A, and the left end portion 342F of the support unit 342 and the light reflecting unit 341 move in the direction separating from the transport path R100.

Similarly to the above, the moving mechanism 354 that moves the light reflecting unit 341 and the support unit 342 may have other configurations.

For example, a rack and pinion mechanism may be used to move the support unit 342 and the light reflecting unit 341. In addition, for example, a solenoid may be used to move the support unit 342 and the light reflecting unit 341.

Here, also in the configuration examples illustrated in FIG. 10 and FIG. 11, similarly to the above, the light reflecting unit 341 and the support unit 342 move in the thickness direction of the sheet P to be transported along the transport path R100.

However, this is not a limitation. The light reflecting unit 341 and the support unit 342 may be configured to move in the width direction of the sheet P to be transported on the transport path R100.

Also in this configuration example, the body unit 303 of the imaging mechanism 300 is provided on the lower side of the transport path R100, and the light reflecting unit 341 and the support unit 342 are retracted to the lower side of the transport path R100. However, this is not a limitation. The body unit 303 may be provided on the upper side of the transport path R100, and the light reflecting unit 341 and the support unit 342 may be configured to be retracted to the upper side of the transport path R100.

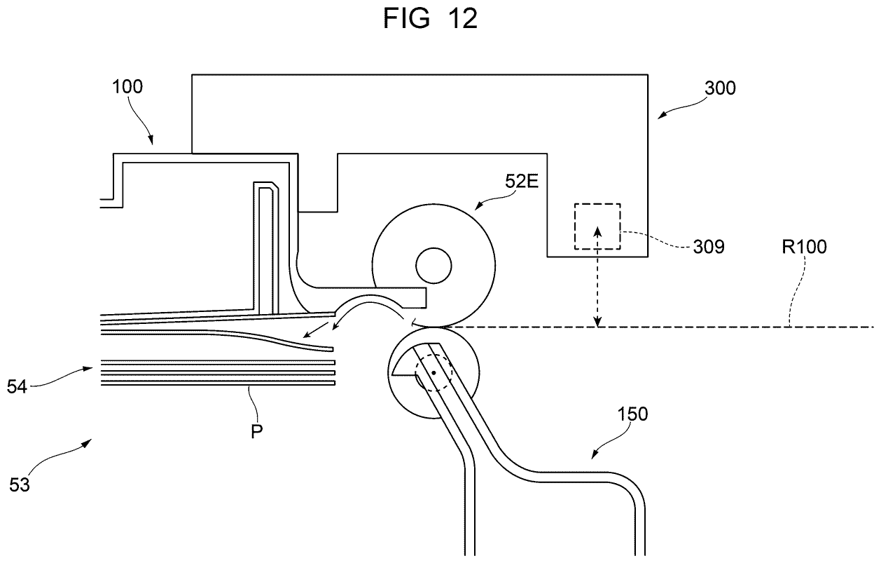

FIG. 12 is a diagram illustrating another configuration example of the imaging mechanism 300.

In the configuration example illustrated in FIG. 12, the imaging mechanism 300 is attached to the suction unit 100, and the imaging mechanism 300 is supported by the suction unit 100.

In this configuration example, a part 309 of the imaging mechanism 300 moves relative to the suction unit 100. The part 309 approaches the transport path R100 and retracts from the transport path R100.

The part 309 may be the light receiving unit 301 or the light reflecting unit 341 described above.

In the configuration example illustrated in FIG. 12, the part 309 of the imaging mechanism 300 approaches the transport path R100 from above the transport path R100 of the sheet P.

Specifically, the light receiving unit 301 and the light reflecting unit 341 approach the transport path R100 of the sheet P from above the transport path R100. Then, the sheet P is imaged in a state where the light receiving unit 301 and the light reflecting unit 341 are close to the transport path R100.

When the light receiving unit 301 and the light reflecting unit 341 are retracted, the light receiving unit 301 and the light reflecting unit 341 move upward. Thus, the light receiving unit 301 and the light reflecting unit 341 are retracted from the transport path R100.

In the configuration example illustrated in FIG. 12, the light receiving unit 301 and the light reflecting unit 341 move on the downstream side of the most-upstream transport roller 52E in the transport direction of the sheet P.

However, this is not a limitation. When the clearance between the suction unit 100 and the most-upstream transport roller 52E is large, the light receiving unit 301 and the light reflecting unit 341 may be moved in the clearance.

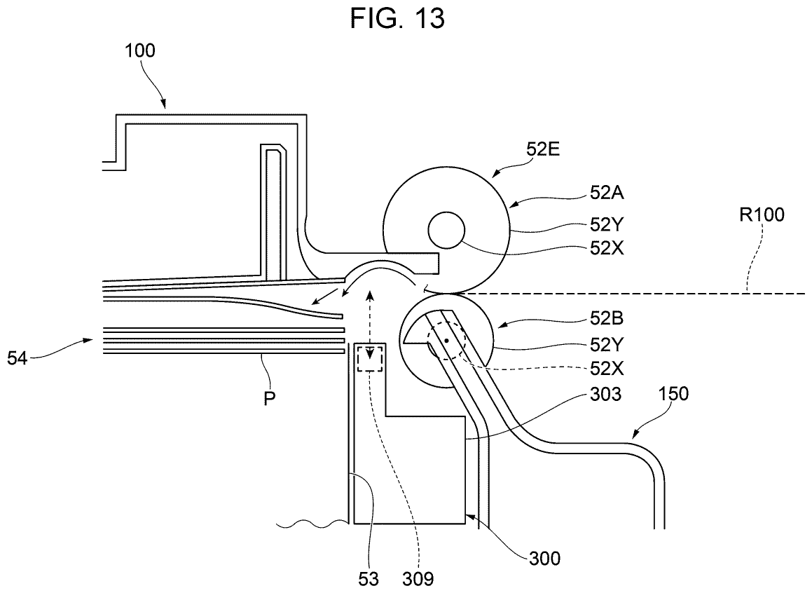

FIG. 13 is a diagram illustrating another configuration example of the imaging mechanism 300.

In this configuration example, the part 309 of the imaging mechanism 300 is located on the downstream side of the storage unit 53 in the transport direction of the sheet P, and on the upstream side of the rotation shaft 52X of each of the drive roller 52A and the driven roller 52B, which are provided in the most-upstream transport roller 52E in the transport direction of the sheet P.

The drive roller 52A and the driven roller 52B provided on the most-upstream transport roller 52E are rotating members. In this configuration example, the part 309 of the imaging mechanism 300 that moves is located on the upstream side in the transport direction of the sheet P relative to the rotation shaft 52X of each of the rotating members.

In the configuration examples illustrated in FIGS. 8 to 12, the part of the imaging mechanism 300 that moves is located on the downstream side of the storage unit 53 in the transport direction of the sheet P and on the downstream side of the rotation shaft 52X of each of the drive roller 52A and the driven roller 52B provided in the most-upstream transport roller 52E in the transport direction of the sheet P.

In contrast, in the configuration example illustrated in FIG. 13, the part 309 of the imaging mechanism 300 that moves is located on the upstream side in the transport direction of the sheet P with respect to the rotation shaft 52X of each of the drive roller 52A and the driven roller 52B provided in the most-upstream transport roller 52E.

Here, as the part 309 of the imaging mechanism 300 that moves, the light receiving unit 301 and the light reflecting unit 341 may be given as examples, similar to as described above.

In the case of the configuration example illustrated in FIG. 13, the drive roller 52A and the driven roller 52B are not located between the part 309 of the imaging mechanism 300 and the sheets P to be imaged.

In this case, the area of imaging performed by the light receiving unit 301 (not illustrated in FIG. 13) is not narrowed by the drive roller 52A and the driven roller 52B. In other words, in the configuration example illustrated in FIG. 13, the drive roller 52A and the driven roller 52B do not enter the area of the angle of view of the light receiving unit 301.

In this case, problems such as the sheet P to be imaged being located behind the drive roller 52A and the driven roller 52B and therefore not being able to be imaged are less likely to occur.

In the configuration example illustrated in FIG. 13, a part of the body unit 303 of the imaging mechanism 300 is located on the downstream side in the transport direction of the sheet P with respect to the rotation shaft 52E of each of the drive roller 52A and the driven roller 52B provided in the most-upstream transport roller 52X.

Not all of the portions of the imaging mechanism 300 may be located on the upstream side in the transport direction of the sheet P with respect to the rotation shaft 52X of each of the drive roller 52A and the driven roller 52B provided in the most-upstream transport roller 52E. Portions other than the light receiving unit 301 and the light reflecting unit 341 may be located on the downstream side in the transport direction of the sheet P with respect to the rotation shaft 52X.

### Others

In the configuration examples described above, the light receiving unit 301 or the light reflecting unit 341, which is part of the imaging mechanism 300, is configured to cross the transport path R100. However, the imaging mechanism 300 may not cross the transport path R100.

In other words, a part of the imaging mechanism 300 may be moved in the direction approaching the transport path R100 or in the direction separating from the transport path R100 without the part crossing the transport path R100.

Even when the imaging mechanism 300 does not cross the transport path R100, if a part of the imaging mechanism 300 is moved in the direction approaching the transport path R100, the light receiving unit 301 or the light reflecting unit 341 can be located at a position that facilitates the imaging of the sheet P.

In the foregoing, the configurations in which only a part of the imaging mechanism 300, such as the light receiving unit 301 or the light reflecting unit 341, moves with respect to the transport path R100 have been described. However, a configuration in which not only a part of the imaging mechanism 300 but the entire imaging mechanism 300 moves with respect to the transport path R100 may be employed.

In other words, a configuration may be employed in which the entirety of the imaging mechanism 300 moves in the direction approaching the transport path R100 or in the direction separating from the transport path R100.

Timings of movement of the light receiving unit 301 and the light reflecting unit 341 will be described.

In the present exemplary embodiment, basically, after imaging of the sheet P by the imaging mechanism 300 is performed, the above-described part of the imaging mechanism 300 moves in the direction separating from the transport path R100. Thus, when the transport of the sheet P from the storage unit 53 is started later, the part is located at a position away from the transport path R100.

For example, the light receiving unit 301 and the light reflecting unit 341 may be disposed on the side closer to the transport path R100 at a timing other than the timing at which the transport of the sheet P from the storage unit 53 is started.

In this case, the light receiving unit 301 and the light reflecting unit 341 are retracted from the transport path R100 whenever the timing is reached to start the transport of the sheet P. When the sheet P passes through the imaging mechanism 300, the light receiving unit 301 and the light reflecting unit 341 are returned to the side closer to the transport path R100.

In addition, for example, the light receiving unit 301 and the light reflecting unit 341 may be basically retracted to the retracted position 308. In this case, the light receiving unit 301 and the light reflecting unit 341 may be moved to the side closer to the transport path R100 only at a predetermined imaging timing other than the timing at which the sheet P is transported.

More particularly, for example, when the suction of the sheet P by the suction unit 100 has been performed, the light receiving unit 301 and the light reflecting unit 341 may be moved to the side closer to the transport path R100 to image the sheet P, and, thereafter, the light receiving unit 301 and the light reflecting unit 341 may be immediately moved to the retracted position 308.

In the present exemplary embodiment, control for moving the light receiving unit 301 and the light reflecting unit 341 is performed by the CPU 11a as an example of a processor.

The CPU 11a determines whether or not it is a specific timing to move the light receiving unit 301 and the light reflecting unit 341. If it is determined that it is a predetermined specific timing, the CPU 11a activates the imaging mechanism 300 to bring the light receiving unit 301 and the light reflecting unit 341 closer to the transport path R100.

If the CPU 11a determines that another specific timing has come, the CPU 11a activates the moving mechanism 304 to move the light receiving unit 301 and the light reflecting unit 341 in the direction separating from the transport path R100.

### Appendix

(((1)))

A recording medium storage device comprising:
a storage unit that stores a recording medium to be transported;
a blowing unit that blows gas onto the recording medium stored in the storage unit; and
an imaging unit that is disposed on a downstream side of the storage unit in a recording medium transport direction, and that images the recording medium stored in the storage unit, at least a part of the imaging unit being movable in a direction separating from a transport path of the recording medium.
   (((2)))

The recording medium storage device according to (((1))), wherein:
when imaging of the recording medium stored in the storage unit is performed by the imaging unit, the part of the imaging unit is located on the transport path; and
the part located on the transport path moves in the direction separating from the transport path to be located at a position away from the transport path.
   (((3)))

The recording medium storage device according to (((2))), wherein:
the part located on the transport path is a light receiving unit that receives reflected light from the recording medium, or a support unit that supports the light receiving unit; and
the light receiving unit or the support unit moves in the direction separating from the transport path to be located at a position away from the transport path.
   (((4)))

The recording medium storage device according to (((2))), further comprising:
a light receiving unit that receives reflected light from the recording medium;
a light reflecting unit that guides the reflected light from the recording medium to the light receiving unit; and
a support unit that supports the light reflecting unit, wherein
the part located on the transport path is the light reflecting unit or the support unit, and the light reflecting unit or the support unit moves in the direction separating from the transport path to be located at a position away from the transport path.
   (((5)))

The recording medium storage device according to (((1))), wherein
after imaging of the recording medium is performed by the imaging unit, the part moves in the separating direction, and
when transport of the recording medium from the storage unit is started, the part is located at a position away from the transport path.
   (((6)))

The recording medium storage device according to (((5))), wherein, when the part moves in the direction separating from the transport path, the part moves in a thickness direction of the recording medium transported on the transport path.

(((7)))

The recording medium storage device according to (((1))), wherein the part of the imaging unit is movable in a thickness direction of the recording medium transported on the transport path.

(((8)))

The recording medium storage device according to (((1))), further comprising a suction unit that suctions and holds an uppermost recording medium of recording media stored in the storage unit, wherein:
the imaging unit is supported by the suction unit; and
the part moves relative to the suction unit, and the part moves in the direction separating from the transport path.
   (((9)))

The recording medium storage device according to (((1))), wherein the blowing unit blows the gas onto a portion of the recording medium stored in the storage unit, the portion being located on the downstream side in the recording medium transport direction.

(((10)))

The recording medium storage device according to (((1))), further comprising a rotating member which is disposed on the downstream side of the storage unit in the recording medium transport direction and transports the recording medium from the storage unit to the downstream side, wherein
the part of the imaging unit is located on the downstream side of the storage unit in the recording medium transport direction and on an upstream side of a rotation shaft of the rotating member in the recording medium transport direction.
   (((11)))

An image forming apparatus comprising:
a recording medium storage device that stores a recording medium; and
an image forming unit that forms an image on the recording medium supplied from the recording medium storage device, wherein
the recording medium storage device includes the recording medium storage device according to any one of (((1))) to (((10))).

What is claimed is:

1. A recording medium storage device comprising:
a storage unit that stores a recording medium to be transported;
a blowing unit that blows a gas onto the recording medium stored in the storage unit; and
an imaging unit that is disposed on a downstream side of the storage unit in a recording medium transport direction, and that images the recording medium stored in the storage unit, at least a part of the imaging unit being movable in a direction separating from a transport path of the recording medium.

2. The recording medium storage device according to claim 1, wherein:
when imaging of the recording medium stored in the storage unit is performed by the imaging unit, the part of the imaging unit is located on the transport path; and
the part located on the transport path moves in a direction separating from the transport path to be located at a position away from the transport path.

3. The recording medium storage device according to claim 2, wherein:
the part located on the transport path is a light receiving unit that receives reflected light from the recording medium, or a support unit that supports the light receiving unit; and
the light receiving unit or the support unit moves in a direction separating from the transport path to be located at a position away from the transport path.

4. The recording medium storage device according to claim 2, further comprising:
a light receiving unit that receives reflected light from the recording medium;
a light reflecting unit that guides the reflected light from the recording medium to the light receiving unit; and
a support unit that supports the light reflecting unit, wherein:
the part located on the transport path is the light reflecting unit or the support unit, and the light reflecting unit or the support unit moves in a direction separating from the transport path to be located at a position away from the transport path.

5. The recording medium storage device according to claim 1, wherein:
after imaging of the recording medium is performed by the imaging unit, the part moves in the separating direction; and
when transport of the recording medium from the storage unit is started, the part is located at a position away from the transport path.

6. The recording medium storage device according to claim 5, wherein, when the part moves in the direction separating from the transport path, the part moves in a thickness direction of the recording medium transported on the transport path.

7. The recording medium storage device according to claim 1, wherein the part of the imaging unit is movable in a thickness direction of the recording medium transported on the transport path.

8. The recording medium storage device according to claim 1, further comprising a suction unit that suctions and holds an uppermost recording medium among recording media stored in the storage unit, wherein:
the imaging unit is supported by the suction unit; and
the part moves relative to the suction unit, and the part moves in the direction separating from the transport path.

9. The recording medium storage device according to claim 1, wherein the blowing unit blows the gas onto a portion of the recording medium stored in the storage unit, the portion being located on the downstream side in the recording medium transport direction.

10. The recording medium storage device according to claim 1, further comprising a rotating member that is disposed on the downstream side of the storage unit in the recording medium transport direction, and transports the recording medium from the storage unit to the downstream side, wherein
the part of the imaging unit is located on the downstream side of the storage unit in the recording medium transport direction and on an upstream side of a rotation shaft of the rotating member in the recording medium transport direction.

11. An image forming apparatus comprising:
a recording medium storage device that stores a recording medium; and
an image forming unit that forms an image on the recording medium supplied from the recording medium storage device, wherein
the recording medium storage device includes the recording medium storage device according to claim 1.

12. An image forming apparatus comprising:
a recording medium storage device that stores a recording medium; and
an image forming unit that forms an image on the recording medium supplied from the recording medium storage device, wherein
the recording medium storage device includes the recording medium storage device according to claim 2.

13. An image forming apparatus comprising:
a recording medium storage device that stores a recording medium; and
an image forming unit that forms an image on the recording medium supplied from the recording medium storage device, wherein
the recording medium storage device includes the recording medium storage device according to claim 3.

14. An image forming apparatus comprising:
a recording medium storage device that stores a recording medium; and
an image forming unit that forms an image on the recording medium supplied from the recording medium storage device, wherein
the recording medium storage device includes the recording medium storage device according to claim 4.

15. An image forming apparatus comprising:
a recording medium storage device that stores a recording medium; and
an image forming unit that forms an image on the recording medium supplied from the recording medium storage device, wherein
the recording medium storage device includes the recording medium storage device according to claim 5.

16. An image forming apparatus comprising:
a recording medium storage device that stores a recording medium; and
an image forming unit that forms an image on the recording medium supplied from the recording medium storage device, wherein
the recording medium storage device includes the recording medium storage device according to claim 6.

17. An image forming apparatus comprising:
a recording medium storage device that stores a recording medium; and
an image forming unit that forms an image on the recording medium supplied from the recording medium storage device, wherein
the recording medium storage device includes the recording medium storage device according to claim 7.

18. An image forming apparatus comprising:
a recording medium storage device that stores a recording medium; and
an image forming unit that forms an image on the recording medium supplied from the recording medium storage device, wherein
the recording medium storage device includes the recording medium storage device according to claim 8.

19. An image forming apparatus comprising:
a recording medium storage device that stores a recording medium; and
an image forming unit that forms an image on the recording medium supplied from the recording medium storage device, wherein
the recording medium storage device includes the recording medium storage device according to claim 9.

20. An image forming apparatus comprising:
a recording medium storage device that stores a recording medium; and
an image forming unit that forms an image on the recording medium supplied from the recording medium storage device, wherein
the recording medium storage device includes the recording medium storage device according to claim 10.
